(19) United States
(12) Patent Application Publication
(10) Pub. No.: US 2026/0341998 A1
(43) Pub. Date: Oct. 29, 2026

(54) HOUSING AND POWER CONNECTOR

(71) Applicant: BIZLINK INTERNATIONAL CORP., New Taipei City (TW)

(72) Inventors: Hongping SU, New Taipei City (TW); Haoran ZOU, New Taipei City (TW)

(21) Appl. No.: 19/655,740

(22) Filed: Apr. 23, 2026

(30) Foreign Application Priority Data
Apr. 23, 2025 (CN) 202520784304.5

(51) Int. Cl. H01R 13/502

(52) U.S. Cl. CPC H01R 13/502

(57) ABSTRACT

A housing for a power connector including a base, several protrusion portions, and a button module. The several protrusion portions are disposed on the surface of the base and located on a side of a first passage opening of the base. Each of the several protrusion portions has a slot communicating with the first accommodation cavity and being configured to expose a terminal module. The several protrusion portions are spaced apart along a second direction perpendicular to the first direction. The button module is movable along the first direction relative to the base through the passage opening. The button module has a first state in which the button module protrudes from the first passage opening and a second state in which the button module retracts relative to the first passage opening.

### CROSS - REFERENCE TO RELATED APPLICATION

This application claims priority to China Application Serial Number 202520784304.5, filed Apr. 23, 2025, which is herein incorporated by reference in its entirety.

### BACKGROUND

### Field of Invention

The present disclosure relates to a connector. More particularly, the present disclosure relates to a housing and a power connector.

### Description of Related Art

Power connectors are typically used at power output terminals. They serve as interface components that transmit electrical power from power modules (such as uninterruptible power supplies, battery banks, and power distribution units) to downstream equipment, and are commonly used to distribute main power to server racks.

Existing power connectors are typically inserted through the rear panel of a server cabinet and connected to busbar assemblies inside the cabinet to establish an electrical connection. Over time, this connection is prone to loosening, which can cause the electrical connection between the connector and the server cabinet to fail.

### SUMMARY

The present disclosure relates to a housing for a power connector including a base, several protrusion portions, and a button module. The base has a first accommodation cavity and a first passage opening. The several protrusion portions are disposed on the surface of the base and located on a side of the first passage opening. Each of the several protrusion portions has a slot communicating with the first accommodation cavity. The slot is configured to expose a terminal module. An extension direction of the several protrusion portions is defined as a first direction. The several protrusion portions are spaced apart along a second direction perpendicular to the first direction. The button module is movable along the first direction relative to the base through the passage opening. The button module has a first state in which the button module protrudes from the first passage opening and a second state in which the button module retracts relative to the first passage opening.

The present disclosure also relates to a power connector including the housing described above, the terminal module, and a conductive module. The terminal module is disposed in first accommodation cavity and exposed from the slot. The conductive module is electrically connected to the terminal module.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a structural schematic view of a power connector according to an embodiment of the present disclosure;

FIG. 2 is a cross-section view of the power connector shown in FIG. 1 along the cutting plane line A-A;

FIG. 3 is a structural schematic view of the power connector according to another embodiment of the present disclosure;

FIG. 4 is a structural schematic view of a button module of a housing according to an embodiment of the present disclosure;

FIG. 5 is a structural schematic view of a driving member and a driven member according to an embodiment of the present disclosure;

FIG. 6 is a structural schematic view of the housing according to an embodiment of the present disclosure;

FIG. 7 is a structural schematic view of the housing according to another embodiment of the present disclosure;

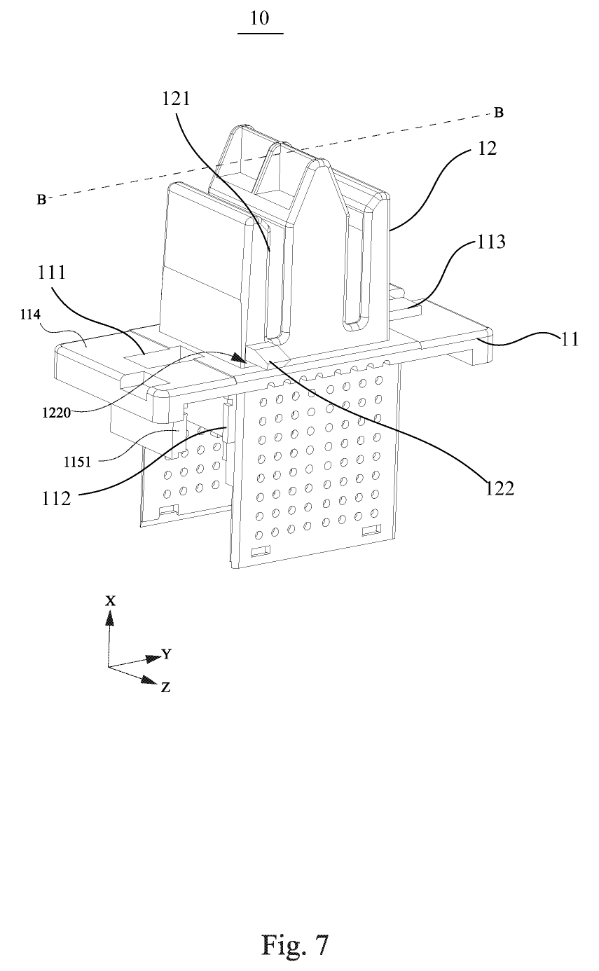

FIG. 8 is a cross-section view of the housing shown in FIG. 7 along the cutting plane line B-B;

FIG. 9 is a structural schematic view of the button module of the housing according to another embodiment of the present disclosure; and

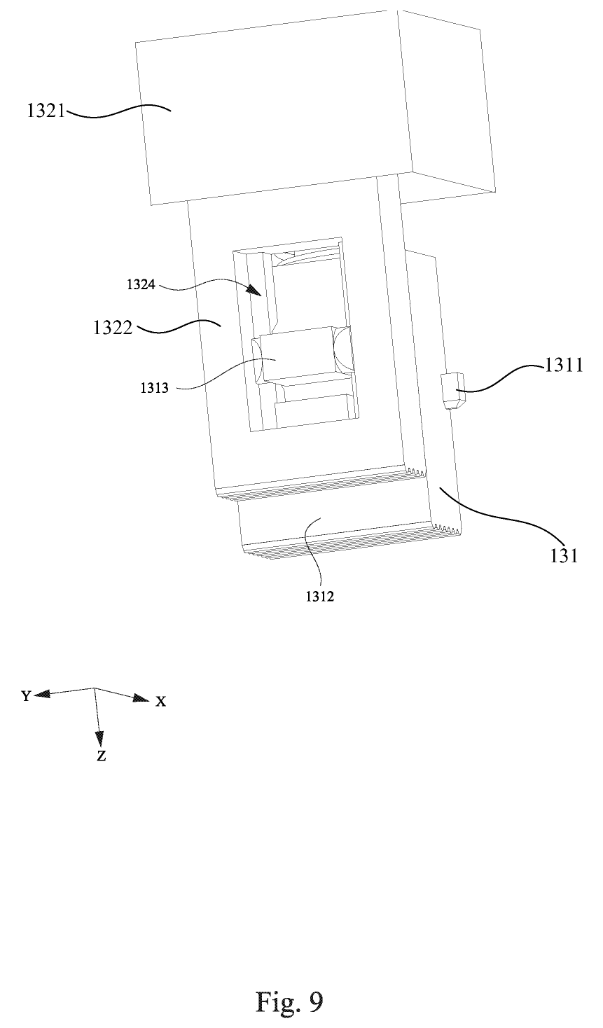

The objectives, functional features, and advantages of the present disclosure will be further described with reference to the drawings and in conjunction with the embodiments.

### DETAILED DESCRIPTION

The technical solutions of the embodiments of the present disclosure will be described clearly and completely below with reference to the drawings. It should be noted that the embodiments described herein are merely some examples of the present disclosure and do not constitute all possible embodiments. All other embodiments obtained by a person skilled in the art based on the embodiments of the present disclosure, without the need for creative effort, fall within the scope of protection of the present disclosure.

It should be noted that where directional terms (such as up, down, left, right, front, back, etc.) are used in the embodiments of the present disclosure, such terms are intended solely to explain the relative positions and movements of the various components in a specific configuration. If that specific configuration changes, the directional terms will change accordingly.

Furthermore, where the embodiments of the present disclosure include descriptions such as “first” or “second,” such designations are used solely for descriptive purposes and should not be construed as indicating or implying relative importance or as implicitly specifying the number of technical features indicated. Accordingly, features designated as “first” or “second” may explicitly or implicitly include at least one such feature. Furthermore, where the terms “and/or” appear throughout the text, they denote three alternative options. For example, “A and/or B” includes option A, option B, or a combination of both A and B. Furthermore, the technical solutions described in the various embodiments may be combined with one another, provided that such combination is feasible for a person skilled in the art. If the combination of technical solutions results in contradictions or is unfeasible, such combination shall be deemed non-existent and shall not fall within the scope of protection claimed by the present disclosure.

To clearly illustrate the spatial relationship and orientation among components, coordinate axes are shown in the figures: a first axis x, a second axis y, and a third axis z.

Power connectors are typically used at power output terminals. They serve as interface components that transmit electrical power from power modules (such as uninterruptible power supplies, battery banks, and power distribution units) to downstream equipment, and are commonly used to distribute main power to server racks.

Existing power connectors are typically inserted through the rear panel of a server cabinet and connected to busbar assemblies therein to establish an electrical connection. However, such connections are prone to loosening over time, which may lead to electrical contact failure between the connector and the server cabinet.

The present disclosure provides a housing and a power connector configured to enhance the stability of connection between the power connector and the server cabinet, thereby preventing electrical connection failures therebetween.

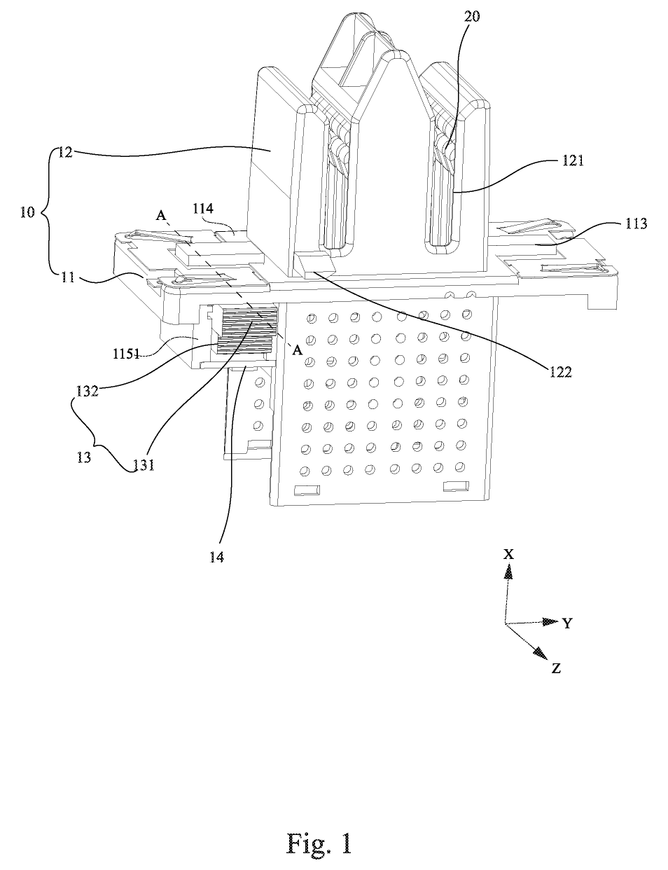

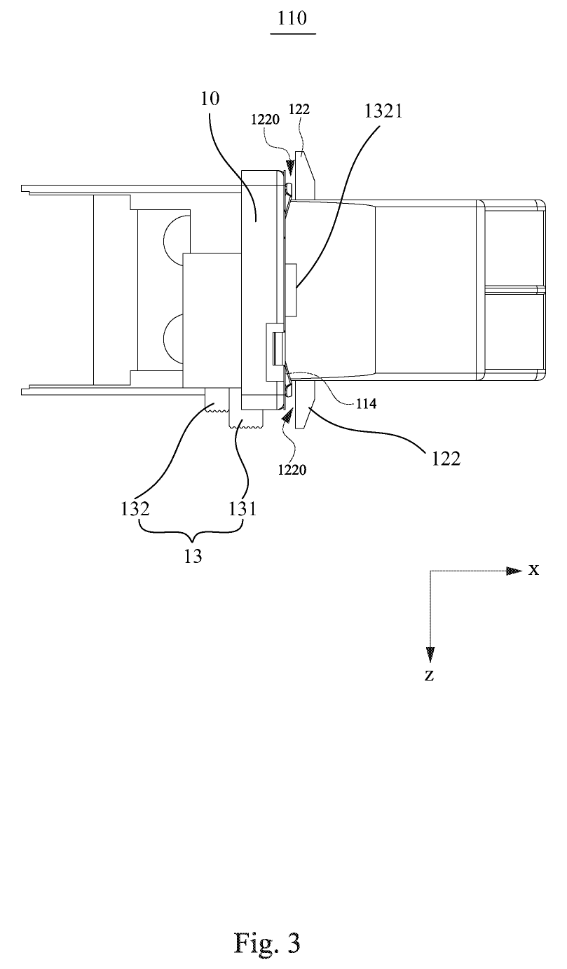

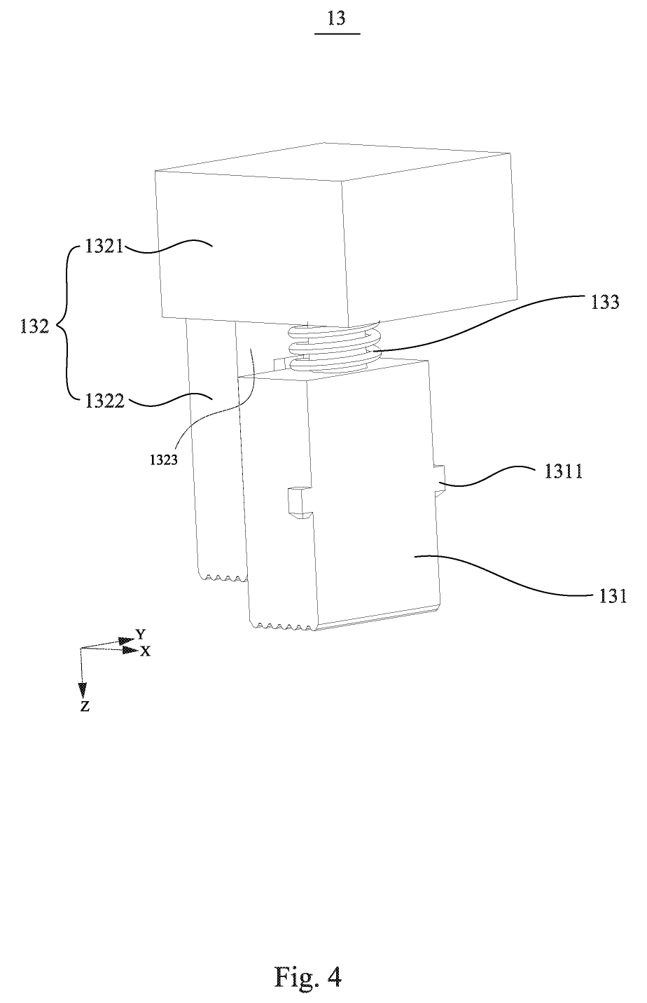

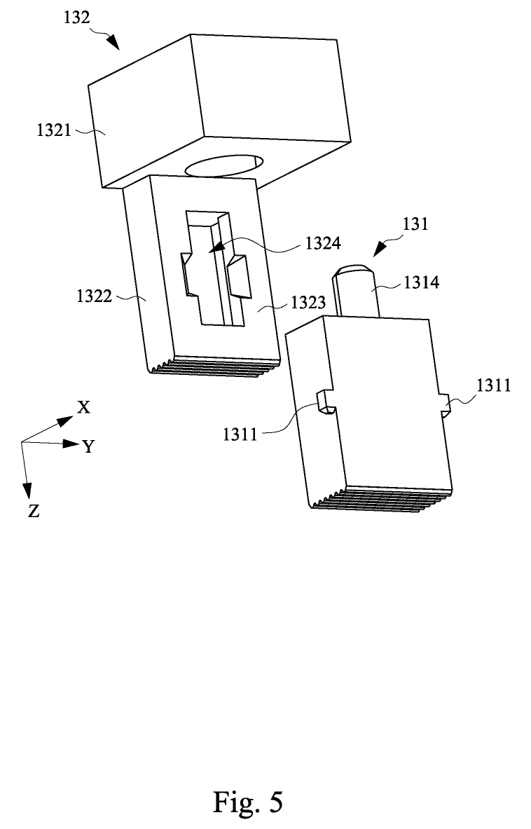

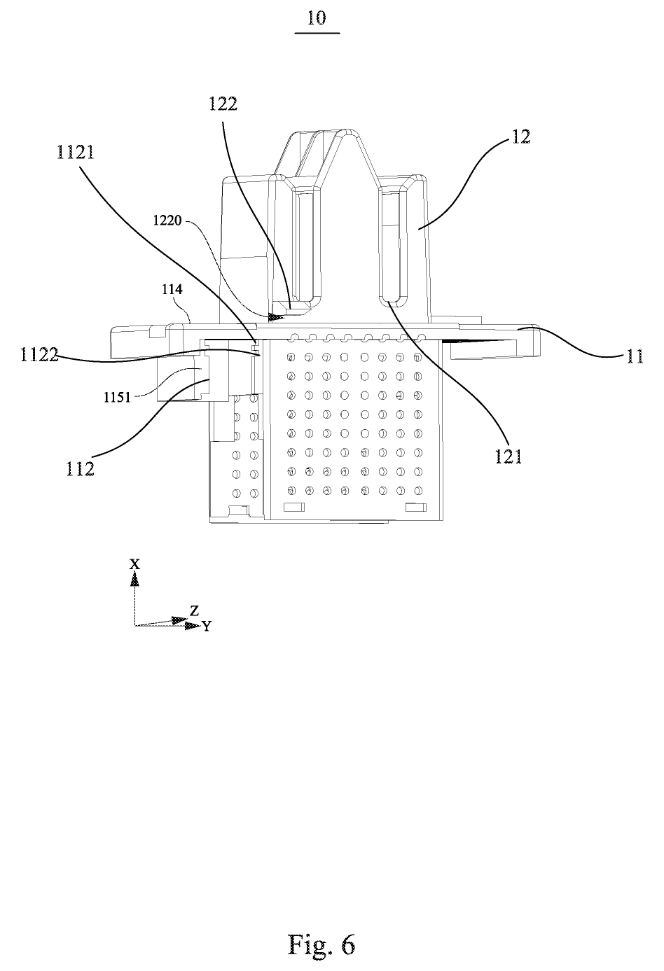

Please refer to FIGS. 1 to 6, in an embodiment of the present disclosure, the housing 10 is used for a power connector 100. The housing 10 includes a base 11, several protrusion portions 12, and a button module 13. The base 11 has a first accommodation cavity 110, a first passage opening 111, and a second accommodation cavity 115. The first passage opening 111 communicates with the first accommodation cavity 110 and is formed on a surface 114 of the base 11. The first accommodation cavity 110 is separated from the second accommodation cavity 115. The second accommodation cavity 115 is disposed adjacent to the first accommodation cavity 110. The first passage opening 111 communicates with the second accommodation cavity 115. A length direction of the base 11 is defined as the first direction (i.e., the first axis x), and a width direction of the base 11 is defined as the second direction (i.e., the second axis y). A third direction (i.e., the third axis z) is defined as being perpendicular to the first direction and the second direction. In other words, an extension direction of the several protrusion portions 12 is defined as the first direction, and an alignment of the several protrusion portions 12 is defined as the second direction that is perpendicular to the first direction. The first direction is parallel to an insertion direction of the power connector 100. The several protrusion portions 12 are disposed on the surface 114 of the base 11 and located on a side of the first passage opening 111. The several protrusion portions 12 are configured to be inserted into a server cabinet. Each of the several protrusion portions 12 includes a slot 121. An end of the slot 121 communicates with the first accommodation cavity 110. The slot 121 is configured to accommodate and expose a terminal module 20. The button module 13 is movably inserted through the first passage opening 111 along the first direction. The button module 13 has a first state in which the button module 13 protrudes from the first passage opening 111 and a second state in which the button module 13 retracts into the first passage opening 111. When the several protrusion portions 12 are inserted into the server cabinet, the button module 13 is in the first state to limit the housing 10 within the server cabinet in the third and second directions.

In some embodiments, the base 11 serves as the main structural component of the housing 10 and may be specifically fabricated from high-strength plastic via injection molding. The first accommodation cavity 110 is an internal hollow structure designed to route the terminal module 20 and conductive modules. The second accommodation cavity 115 is an internal hollow structure designed to accommodate the button module 13. The first passage opening 111 refers to a through-hole formed on the surface 114 of the base 11. A dimension of the first passage opening 111 is slightly larger than the range of motion of the button module 13, allowing the button module 13 to switch positions. The several protrusion portions 12 refer to mating structures extending from the surface 114 of base 11. The slot 121 of each of the several protrusion portions 12 is a through-slot that can be integrally molded with base 11 via injection molding. The slot 121 is used to secure the terminal module 20 and establish a connection path with the cabinet. The button module 13 refers to an operating mechanism containing mechanical linkage components. Specifically, it may adopt a spring-returned slider structure that forms a constraint by contacting an inner wall of the cabinet via a physical stop surface.

Specifically, when the several protrusion portions 12 are inserted into the server cabinet, the button module 13 is driven by an internal mechanism to assume a protruding state. At this point, the exposed portion of the button module 13 makes line contact with the panel of the server cabinet in the third and second directions, restricting the displacement of the housing 10 along the third and second directions.

Compared to the prior art, conventional power connectors rely solely on the friction of the mating structure to maintain the connection and cannot withstand external forces from multiple directions. The design of the power connector 100 of the present disclosure employs a switchable button module to create active positioning, with the button module 13 abutting the rear panel of the server cabinet in the third and second directions. Compared to solutions using single-sided latches or threaded fasteners, this design does not require additional fasteners and achieves multidimensional positioning through the structure of the housing 10 itself. Additionally, the ability to switch the button module 13 between extended and retracted states makes installation and removal more convenient, eliminating the risk of damage caused by tool operation in traditional solutions.

In the technical solution of the present disclosure, the housing 10 for the power connector 100 includes the base 11, the several protrusion portions 12, and the button module 13. The several protrusion portions 12 are disposed on the surface 114 of the base 11. Each of the several protrusion portions 12 has a slot 121 extending through both ends of each of the several protrusion portions 12. The terminal module 20 is disposed in the first accommodation cavity 110 and exposed from the slot 121, and the button module 13 is movably inserted through the first passage opening 111 in the base 11. The button module 13 has the first state in which the button module 13 is exposed on the surface 114 of the base 11 and the second state in which the button module 13 is retracted into the base 11. The several protrusion portions 12 are designed to be inserted into the server cabinet to enable the terminal module 20 to make an electrical connection with the cabinet busbar. When the button module 13 is switched to the first state, it protrudes from the surface 114 of the base 11. When the housing 10 moves relative to the server cabinet, the protruding portion of the button module 13 abuts against the rear panel of the server cabinet, thereby restricting relative movement between the housing 10 and the server cabinet in the third and second directions. This ensures a more stable connection between the power connector 100 and the server cabinet and prevents electrical connection failure between them.

In an embodiment of the present disclosure, the button module 13 includes a driving member 131 and a driven member 132. An end of the driven member 132 is movable relative to the base 11 through the first passage opening 111. The driven member 132 has the first state and the second state. The driving member 131 is movably disposed within the second accommodation cavity 115 and is connected to the other end of the driven member 132. The driving member 131 is movable to drive the driven member 132 to switch between the first state and the second state.

A bottom of the second accommodation cavity 115 has an opening. The housing 10 further includes a cover plate 14, which is detachably connected to the base to cover the opening.

In some embodiments, the driving member 131 refers to an operating component capable of moving within the second accommodation cavity 115. Specifically, the driving member 131 may be implemented using a sliding block or pushrod structure. The function of the driving member 131 is to transmit driving force to the driven member 132 through its own movement. The driven member 132 refers to an actuating component that operates in conjunction with the driving member 131. The driven member 132 can be specifically implemented using a link or slider structure. The function of the driven member 132 is to convert the motion of the driving member 131 into an extension and retraction motion at its end, thereby switching between the first state and the second state. The connection between the driving member 131 and the driven member 132 may be achieved through a hinge, snap-fit, or slide-groove mechanism, ensuring reliable motion transmission and controllable directional movement. An opening is formed in the bottom of the second accommodation cavity 115, and the cover plate 14 is detachably connected to the edge of the opening to secure the button module 13 within the second accommodation cavity 115. Furthermore, the detachable connection of the cover plate 14 allows for the replacement of the button module 13 in the second accommodation cavity 115.

In some embodiments, the specific connection between the driving member 131 and the driven member 132 is such that the driving member 131 has an engaged structure 1313 disposed on a surface 1312 of the driving member 131 toward the driven member 132. A second portion 1322 of the driven member 132 is provided with an engaged slot 1324 on a surface 1323 of the driven member 132. Through the engagement of the engaged structure 1313 and the engaged slot 1324, the engaged structure 1313 can slide along the engaged slot 1324 in the third direction, allowing the driving member 131 to slide relative to a first portion 1321 of the driven member 132 in the third direction. When the driving member 131 is pushed along the third direction, the engaged structure 1313 slides within the engaged slot 1324 to compress the elastic member 133. Subsequently, by moving the driving member 131 along the first direction, the engagement between the engaged structure 1313 and the engaged slot 1324 drives the driven member 132 to move synchronously, such that the driven member 132 is switchable from the second state to the first state.

In an embodiment of the present disclosure, the driving member 131 is driven to move in the third direction to disengage from the limiting groove, so that the button module 13 is switchable between the first state and the second state along the first direction.

In an embodiment of the present disclosure, a second passage opening 112 is formed in a side wall 1151 of the second accommodation cavity 115. The second passage opening 112 communicates with the first passage opening 111.

In some embodiments, the base 11 further includes a side wall 1151 defining the second accommodation cavity 115. The side wall 1151 extends in a direction perpendicular to the surface 114 of the base 11. The second passage opening 112 is formed in the side wall 1151 and communicates with the first passage opening 111.

The driven member 132 includes the first portion 1321 and the second portion 1322 connected to one another. In some embodiments, the first portion 1321 and the second portion 1322 connected to one another at a right angle. The first portion 1321 is movable relative to the base through the first passage opening 111. The second portion 1322 is exposed through the second passage opening 112. The driving member 131 is movable disposed within the second accommodation cavity 115 and partially protruded through the second passage opening 112 of the side wall 1151 for receiving a driving force, whereby the driving member 131 is moved to drive the driven member 132 to switch between the first state and the second. The driving member 131 is located between the second portion 1322 and a cavity wall of the base 11 defining the second accommodation cavity 115.

The driving member 131 is driven to move in the third direction to cause the driven member 132 to switch between the first state and the second state. In some embodiments, the driving member 131 is driven to abut against the second portion 1322 of the driven member 132 to drive the driven member 132 to switch between the first state and the second state.

In some embodiments, the second passage opening 112 is an opening formed in the side wall 1151 of the second accommodation cavity 115. The second passage opening 112 can be created through stamping or cutting processes. The function of the second passage opening 112 is to provide a passage space and a support surface for the second portion 1322 of the driven member 132. The first portion 1321 and the second portion 1322 constitute the two-part structure of the driven member 132, which can be specifically realized through either integral molding or separate assembly. The first portion 1321 is used to perform a limiting function, while the second portion 1322 is used to transmit driving force. The positional relationship of the driving member 131 between the second portion 1322 and the cavity wall of the second accommodation cavity 115 can be achieved through a slide rail or guide groove structure, and its function is to convert linear motion in the third direction into a state-switching action of the driven member 132.

In some embodiments, the first portion 1321 and the second portion 1322 of the driven member 132 are connected at right angles, and the second passage opening 112 is formed in the side wall 1151 to allow electrical connection wires to pass through, thereby preventing the wires from obstructing the driving of the driving member 131.

In some embodiments, the base 11 is a plate-like structure. The second accommodation cavity 115 is formed by three side walls connected end-to-end, the cover plate 14 that snaps onto the three side walls, and the other surface of the base 11. The opening formed by this enclosure serves as the second passage opening 112. The driving member 131 and the driven member 132 are movably mounted within the second accommodation cavity 115. The cover plate 14 acts as a stop to prevent the driving member 131 from moving too far and disengaging from the second accommodation cavity 115.

In an embodiment of the present disclosure, the base 11 has a first limiting groove 1121 and a second limiting groove 1122 formed on a wall surface of the side wall 1151. The first limiting groove 1121 and the second limiting groove 1122 are spaced apart along the second direction. The first limiting groove 1121 is closer to the surface 114 of the base 11 than the second limiting groove 1122. In some embodiments, the second passage opening 112 has two of the first limiting groove 1121 disposed on opposite inner sides of the second passage opening 112. The second passage opening 112 has two of the second limiting groove 1122 disposed on opposite inner sides of the second passage opening 112. The first limiting groove 1121 and the second limiting groove 1122 extend along the second direction, with both grooves open at their ends. The driving member 131 has limiting portions 1311 protruding from its opposite sides. Each of the limiting portions 1311 can be engaged within either the first limiting groove 1121 or the second limiting groove 1122.

When the limiting portions 1311 are engaged in the first limiting groove 1121, the driven member 132 is in the first state.

When the limiting portions 1311 are engaged in the second limiting groove 1122, the driven member 132 is in the second state.

In some embodiments, the first limiting groove 1121 and the second limiting groove 1122 are recessed structures formed on an edge of the second passage opening 112. Specifically, the first limiting groove 1121 and the second limiting groove 1122 may be formed by milling to create two parallel straight grooves, which provide a sliding track for the limiting portions 1311 through their extension along the second direction. The limiting portions 1311 are protruding block structures located on both sides of the driving member 131. Specifically, the limiting portions 1311 can be formed using an injection molding process into a rectangular protrusion matching the width of the first limiting groove 1121 and the second limiting groove 1122, achieving mechanical locking of the position of the driving member 131 by engaging with the first limiting groove 1121 and the second limiting groove 1122 at different positions. In some embodiments, a vertical slide groove extending in the third direction connects the first limiting groove 1121 and the second limiting groove 1122, forming a C-shaped slide groove including the first limiting groove 1121, the vertical slide groove, and the second limiting groove 1122. The limiting portions 1311 can slide along the C-shaped slide groove to move between the first limiting groove 1121 and the second limiting groove 1122.

In an embodiment of the present disclosure, the first limiting groove 1121 is disposed adjacent to the second limiting groove 1122.

When the driving member 131 is moved along the first and third directions, it causes the limiting portions 1311 to move from the first limiting groove 1121 into the second limiting groove 1122. The driving member 131 causes the driven member 132 to switch to the second state. More specifically, the driving member 131 first receives a force along the third direction and moves relative to the driven member 132 (i.e., the limiting portions 1311 move within a sliding slot 1324 of the driven member 132). Subsequently, as the driving member 131 receives a force along one side of the first direction, it engages and drives the driven member 132 to move together along this side of the first direction to complete the switching to the second state.

When the driving member 131 is moved along the first and third directions, it causes the limiting portions 1311 to move from the second limiting groove 1122 into the first limiting groove 1121. The driving member 131 causes the driven member 132 to switch to the first state. More specifically, the driving member 131 first moves along the third direction relative to the driven member 132 via the sliding slot 1324. Then, the driving member 131 receives a force along the other side of the first direction (opposite to the aforementioned side), thereby driving the driven member 132 to move synchronously along the opposite direction of the first direction to return to the first state.

In some embodiments, “the first limiting groove 1121 is disposed adjacent to the second limiting groove 1122” refers to one set of the first limiting groove 1121 and the second limiting groove 1122 being arranged on a side in the first direction and sharing an edge of the second passage opening 112. The arrangement of the first limiting groove 1121 and the second limiting groove 1122 allows the limiting portion 1311 to move along the first direction to securely engage with either the first limiting groove 1121 or the second limiting groove 1122. This configuration requires only a slight displacement in the third direction to facilitate the switching process, thereby shortening the operating stroke.

In some embodiments of the present disclosure, an elastic member 133 is disposed between the driving member 131 and the first portion 1321 of the driven member 132. The elastic member 133 is configured to push the driving member 131 along the third direction to expose the driving member 131 through the second passage opening 112.

In some embodiments, the elastic member 133 may be a coil spring, an elastic rubber block, or a leaf spring, which stores energy through elastic deformation and releases a driving force. When the driving member 131 is protruded at the second passage opening 112, the elastic member 133 is in an unloaded state. When the driving member 131 is pushed in the third direction, the elastic member 133 is compressed by an external force. Upon release, the elastic member 133 returns to its original shape, pushing the driving member 131 out of the second passage opening 112. This prevents the housing 10 from becoming loose at the limit position due to a failure of the button module 13 to reset, ensuring that the engagement between the driving member 131 and the limiting groove remains in the preset state at all times. This enhances the installation stability of the housing 10 within the server cabinet and improves the reliability of electrical connections.

In an embodiment, the driving member 131 and the driven member 132 of the button module 13 are stacked in a first direction. The elastic member 133 is disposed between the driving member 131 and the first portion 1321 of the driven member 132. The driving member 131 is slidably connected to the second portion 1322 of the driven member 132. A guide pin 1314 may be provided on the driving member 131, with the elastic member 133 threaded onto the guide pin to ensure stable deformation of the elastic member 133.

In an embodiment of the present disclosure, the base 11 has a projection 113 located on a surface of the base 11. The projection 113 is on a side of one of the several protrusion portions 12 opposite the first passage opening 111. The projection 113 is configured to limit a movement of the housing 10 along the third and second directions within the server cabinet.

In some embodiments, when the housing 10 is inserted into the mounting holes of the server cabinet, the projection 113 and the button module 13 are respectively located on opposite sides of the mounting holes. Once the adjacent surfaces of the projection 113 come into contact with an inner wall of the mounting hole, they directly prevent the housing 10 from shifting in the third and second directions. Through the bidirectional limiting engagement formed with the button module 13, the projection 113 eliminates displacement degrees of freedom of the housing 10 in the orthogonal plane, thereby preventing connection loosening caused by vibration or insertion/removal forces.

In an embodiment of the present disclosure, one of the several protrusion portions 12 has a stopper 122 on a side in the third direction. The stopper 122 extends along the third direction. A locking groove 1220 is formed between the stopper 122 and the surface 114 of the base 11. The locking groove 1220 is configured to clamp a rear panel of the server cabinet. The stopper 122 is configured to limit the movement of the housing 10 in the first direction within the server cabinet.

In some embodiments, when the housing 10 is inserted into the server cabinet, the rear panel is clamped by the locking groove 1220. The gap formed between the stopper 122 and the surface 114 of the base 11 restricts the movement of the rear panel in the first direction. At the same time, the structure of the stopper 122 extending in the third direction directly prevents the housing 10 from shifting in the insertion/removal direction. A length of the stopper 122 covers a contact area between the rear panel and the housing 10, enhancing clamping stability by increasing the contact area. A depth of the locking groove 1220 is precisely matched to a height of the stopper 122, ensuring the rear panel does not become disengaged during the clamping process.

In an embodiment of the present disclosure, a number of the stopper 122 is two. The two stoppers 122 are disposed on opposite sides of the several protrusion portions 12, respectively.

In some embodiments, the two stoppers 122 are respectively located on two sides of the several protrusion portions 12 in the third direction. When the housing 10 is inserted into the server cabinet, the edge of the rear panel the server cabinet is engaged in the locking grooves 1220 formed by the two stoppers 122 and the surface 114 of the base 11. Since the two stoppers 122 are symmetrically distributed, the clamping force is uniformly applied to both edges of the rear panel, preventing tilting or loosening caused by force applied to only one side. The two stoppers 122 simultaneously provide bidirectional restraint to the rear panel, limiting the forward and backward displacement of the housing 10 along the first direction and ensuring the stability of the connection between the housing 10 and the server cabinet.

The present disclosure further relates to a power connector 100 comprising the housing 10, the terminal module 20, and the conductive module described above. The terminal module 20 is disposed in the slot 121 of the housing 10 and protrudes from the slot 121. An end of the conductive module is electrically connected to the terminal module 20. The other end of the conductive module protrudes from the housing 10.

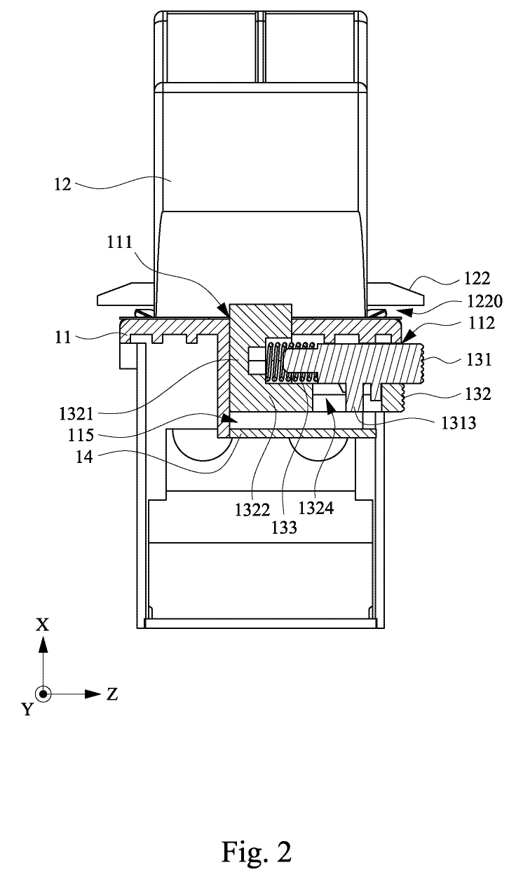

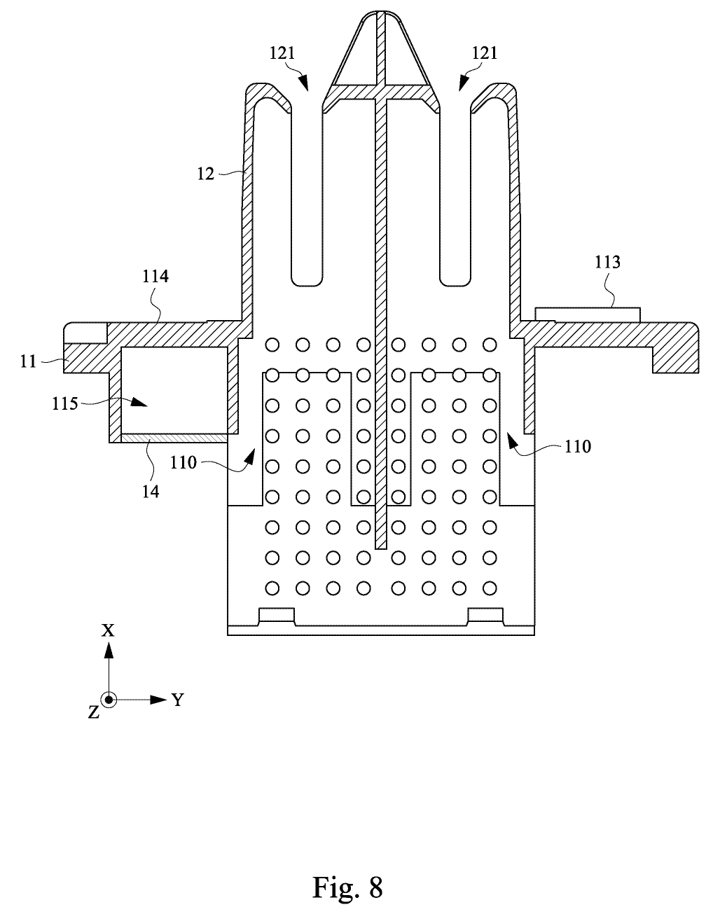

In an embodiment of the present disclosure, referring to FIG. 1, FIG. 2, and FIG. 8, in the present embodiment, when the housing 10 is inserted through a mounting hole of an external panel, the locking portion 1321 is initially in a retracted state. As the housing 10 moves relative to the external panel along a second direction to allow an edge of the external panel to enter the locking slot 1220 defined by the stopper 122, the locking portion 1321 is driven to switch from the retracted state to a protruding state. In this state, the projection 113 is configured to at least limit a movement of the housing 10 along the second direction, and may further simultaneously limit the movement along a third direction. Specifically, the projection 113 and the locking portion 1321 respectively abut against two corresponding sides of the mounting hole, thereby forming lateral restrictions along the second direction. Furthermore, through the synergistic cooperation of the projection 113, the locking portion 1321, and the stopper 122, displacement restrictions in three-dimensional directions are collectively achieved: (1) In the first direction, movement along the insertion or extraction direction is restricted by securing the panel within the locking slot 1220; (2) In the second direction, displacement is restricted by the lateral abutment formed by the locking portion 1321 and the projection 113; and (3) In the third direction, shaking of the housing 10 is restricted by the stopper 122 and the projection 113 / locking portion 1321 filling the vertical clearance of the mounting hole. This collective locking mechanism ensures that the power connector is securely fixed to the external panel.

In an embodiment of the present disclosure, a method for mounting the power connector 100 to the server cabinet includes: switching the button module 13 to the second state (i.e., retracted or unlocked state) (step S101); inserting the power connector 100 into an opening of a panel of the server cabinet (step S102); moving the power connector 100 into a mounting position until the rear panel of the server cabinet is clamped within the locking groove 1220 formed between the stopper 122 and the surface 114 of the base 11 (step S103); pushing the driving member 131 of the button module 13 along the third direction to compress the elastic member 133 and disengage the limiting portions 1311 from the second limiting groove 1122 (step S104); moving the button module 13 along the first direction to drive the driven member 132 synchronously, causing the first portion 1321 of the button module 13 to protrude from the surface 114 of the base 11 through the first passage opening 111(step S105); and releasing the driving member 131 to allow the compressed elastic member 133 to move the driving member 131 along the third direction, thereby seating the limiting portions 1311 into the first limiting groove 1121 to lock the button module 13 in the first state (step S106).

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A housing for a power connector, comprising:
a base having a first accommodation cavity and a first passage opening formed on a surface of the base;
a plurality of protrusion portions disposed on the surface of the base and located on a side of the first passage opening, each of the plurality of protrusion portions having a slot communicating with the first accommodation cavity, the slot being configured to expose a terminal module, an extension direction of the plurality of protrusion portions being defined as a first direction, and the plurality of protrusion portions being spaced apart along a second direction perpendicular to the first direction; and
a button module movable along the first direction relative to the base through the first passage opening, the button module having a first state in which the button module protrudes from the first passage opening and a second state in which the button module retracts relative to the first passage opening.

2. The housing of claim 1, wherein the button module comprises a driving member and a driven member, an end of the driven member is movable relative to the base through the first passage opening, the driving member is connected to the other end of the driven member, and the driving member is movable to drive the driven member to switch between the first state and the second state.

3. The housing of claim 2, wherein the base further has a second accommodation cavity disposed adjacent to the first accommodation cavity, the first passage opening communicates with the second accommodation cavity, and the driving member is movably disposed within the second accommodation cavity.

4. The housing of claim 3, wherein the base has an opening at a bottom of the second accommodation cavity, and the housing further comprises a cover plate connected to the base to cover the opening.

5. The housing of claim 3, wherein the base further comprises a side wall defining the second accommodation cavity, the side wall extends in a direction perpendicular to the surface of the base, and a second passage opening is formed in the side wall and communicates with the first passage opening.

6. The housing of claim 5, wherein the driven member comprises a first portion and a second portion connected to the first portion, the first portion is movable relative to the base through the first passage opening, and the second portion is exposed through the second passage opening.

7. The housing of claim 6, wherein the driving member is partially protruded through the second passage opening of the side wall for receiving a driving force, whereby the driving member is moved to drive the driven member to switch between the first state and the second state.

8. The housing of claim 7, wherein the driving member is located between the second portion of the driven member and a cavity wall of the base defining the second accommodation cavity, and the driving member is driven to abut against the second portion of the driven member to drive the driven member to switch between the first state and the second state.

9. The housing of claim 5, wherein the base has a first limiting groove and a second limiting groove formed on a wall surface of the side wall, the first limiting groove and the second limiting groove are spaced apart along the first direction, and the first limiting groove is closer to the surface of the base than the second limiting groove, the first limiting groove and the second limiting groove extend along the second direction, and the first limiting groove and the second limiting groove are open at both ends.

10. The housing of claim 9, wherein the driving member has a limiting portion protruding from a side of the driving member, and the limiting portion is engaged in one of the first limiting groove or the second limiting groove.

11. The housing of claim 10, wherein the driven member is in the first state when the limiting portion is engaged in the first limiting groove, and the driven member is in the second state when the limiting portion is engaged in the second limiting groove.

12. The housing of claim 10, wherein the first limiting groove is disposed adjacent to the second limiting groove.

13. The housing of claim 12, wherein the driving member drives the driven member to switch to the second state when the driving member is driven to move along the first direction and a third direction perpendicular to the first direction and the second direction to make the limiting portion move from the first limiting groove into the second limiting groove.
;

14. The housing of claim 12, wherein the driving member drives the driven member to switch to the first state when the driving member is driven to move along the first direction and a third direction perpendicular to the first direction and the second direction to make the limiting portion move from the second limiting groove into the first limiting groove.

15. The housing of claim 7, wherein an elastic member is disposed between the driving member and the first portion of the driven member, and the elastic member is configured to push the driving member along a third direction perpendicular to the first direction and the second direction to expose the driving member through the second passage opening.

16. The housing of claim 15, wherein the base has a projection located on a surface of the base, the projection is on a side of the plurality of protrusion portions opposite the first passage opening, and the projection is configured to limit a movement of the housing along the second direction.

17. The housing of claim 15, wherein at least one of the plurality of protrusion portions has at least one stopper, and the at least one stopper extends along the third direction.

18. The housing of claim 17, wherein a locking groove is formed between the at least one stopper and the surface of the base, the locking groove is configured to clamp a rear panel of a server cabinet, and the at least one stopper is configured to limit a movement of the housing along the first direction.

19. The housing of claim 18, wherein a number of the at least one stopper is two, and the two stoppers are disposed on opposite sides of the plurality of protrusion portions respectively.

20. A power connector, comprising:
a housing, comprising:
a base having a first accommodation cavity and a passage opening formed on a surface of the base;
a plurality of protrusion portions disposed on the surface of the base and located on a side of the passage opening, each of the plurality of protrusion portions having a slot communicating with the first accommodation cavity, an extension direction of the plurality of protrusion portions being defined as a first direction, and the plurality of protrusion portions being spaced apart along a second direction perpendicular to the first direction; and
a button module movable along the first direction relative to the base through the passage opening, the button module having a first state in which the button module protrudes from the passage opening and a second state in which the button module retracts relative to the passage opening;
a terminal module disposed in the first accommodation cavity and exposed from the slot; and
a conductive module electrically connected to the terminal module.
